(19) United States
(12) Patent Application Publication
(10) Pub. No.: US 2006/0274274 A1
(43) Pub. Date: Dec. 7, 2006

(54) Projection type display apparatus and optical unit used therefor

(76) Inventors: Kei Adachi, Yokohama (JP); Koji Hirata, Yokohama (JP); Masahiko Yatsu, Fujisawa (JP)

Correspondence Address: MCDERMOTT WILL & EMERY LLP, 600 13TH STREET, N.W., WASHINGTON, DC, 20005-3096, US

(21) Appl. No.: 11/445,465

(22) Filed: Jun. 2, 2006

(30) Foreign Application Priority Data
Jun. 3, 2005 (JP) 2005-163649

(51) Int. Cl. G03B 21/14

(52) U.S. Cl. 353/20

(57) ABSTRACT

The present invention provides a technique which can enhance contrast and brightness of a displayed image in a projection image display apparatus. According to the present invention, as a polarization splitting unit polarization-splitting incident light or exiting light upon/from a light valve, F number of a polarization splitting plane formed between prism members in an axial direction in which an incident angle of light is small (Y-axis direction) is smaller than F number in an axial direction in which an incident angle is large (X′-axis direction or Z′-axis direction) so that the light is incident so as to be tilted in the axial direction in which the incident angle is small. This can suppress an amount of change in incident angle of light upon a polarization splitting plane to a small value and can increase an amount of incident light upon the polarization splitting plane in the state that polarization-splitting performance is maintained in the best range.

### CLAIM OF PRIORITY

The present application claims priority from Japanese application serial No. P2005-163649, filed on Jun. 3, 2005, the content of which is hereby incorporated by reference into this application.

### BACKGROUND OF THE INVENTION

1 Technical Field of the Invention

The present invention relates to a projection image display apparatus. It relates particularly to a polarization-splitting technique of polarization splitting light applied onto a light valve such as a liquid crystal panel and the light modulated by the light valve.

2. Description of the Related Art

There is a prior art related to the present invention described in Japanese Patent Publication No. 2001-142028. The publication describes, as a polarization-splitting means, a polarized beam splitter (hereinafter, called PBS) prism formed with a PBS as a dielectric multilayer film at the interface of two right-angle prisms.

### SUMMARY OF THE INVENTION

When the PBS prism as a polarization splitting member in the prior art is used to enhance brightness, it is considered that F number of an incident light is reduced to increase the amount of incident light upon the PBS prism. Making the entire PBS prism larger to increase the amount of incident light is not preferable in view of making the device compact. When F number of incident light is reduced to increase the amount of incident light upon the PBS prism, an incident angle of light upon the PBS film surface is larger to lower contrast. The PBS film surface has an optimum incident angle of light. When light is incident at an angle other than substantially 45Ω upon the PBS film surface in a plane (principal plane of incidence) formed by an optical axis and the normal to the PBS film surface, contrast can be greatly lowered.

The present invention provides a projection image displaying technique which can enhance brightness of a displayed image to secure predetermined contrast performance and can display a bright image of high quality in a projection image display apparatus.

In the present invention, F number of incident light upon the polarization splitting plane of a polarization splitting member is different according to the axial direction of the incident light. Specifically, F number in a first direction orthogonal to an optical axis of incident light and orthogonal to a plane including the optical axis and the normal to the polarization splitting plane is smaller than F number in a second direction orthogonal to an optical axis of the incident light and in parallel with a plane including the optical axis and the normal to the polarization splitting plane. When the polarization splitting plane is in a rectangle shape, F number of the incident light in the long side direction of the rectangle is smaller than F number thereof in the short side direction of the rectangle.

The present inventors have found that the amount of lowered contrast when the incident angle of light upon the polarization splitting plane is changed in the first direction is smaller than the amount of lowered contrast when the incident angle of light upon the polarization splitting plane is changed in the second direction. The present invention has been made in view of such findings. F number in the first direction of the incident light upon the polarization splitting plane is smaller than F number in the second direction thereof to increase the amount of incident light while suppressing lowered contrast. The amount of change in the incident angle of light upon the polarization splitting plane is reduced to a small value. The amount of incident light upon the polarization splitting plane can be increased in the state that polarization-splitting performance is maintained in the best range. Polarization-splitting performance is maintained in the best range so that image contrast performance can be secured. The amount of incident light is increased to enhance image brightness.

The aspect ratio of the plane of light incidence in the polarization splitting unit is larger than 16:9 (that is, 16/9). This increases the amount of incident light in the first direction. The aspect ratio of the light incident plane is preferably 18:9 (18/9) to 24:9 (24/9).

According to the present invention, the projection image displaying technique of a simple construction can enhance brightness in the state of securing image contrast performance.

### BRIEF DESCRIPTION OF THE DRAWINGS

FIG. 1 is a block diagram of a projection image display apparatus as an embodiment of the present invention;

FIG. 2 is an appearance view of a combined construction of polarization splitting units and a color combination unit of the projection image display apparatus of FIG. 1;

FIG. 3 is an appearance view of a polarization splitting member forming the polarization splitting unit shown in FIG. 2; and

FIG. 4 is a diagram of assistance in explaining incident angles of lights in the polarization splitting unit of the projection image display apparatus of FIG. 1.

### DETAILED DESCRIPTION OF THE PREFERRED EMBODIMENT

A best mode for embodying the present invention will be described below using the drawings. Components having the same constructions and features throughout all the drawings are indicated by similar reference numerals.

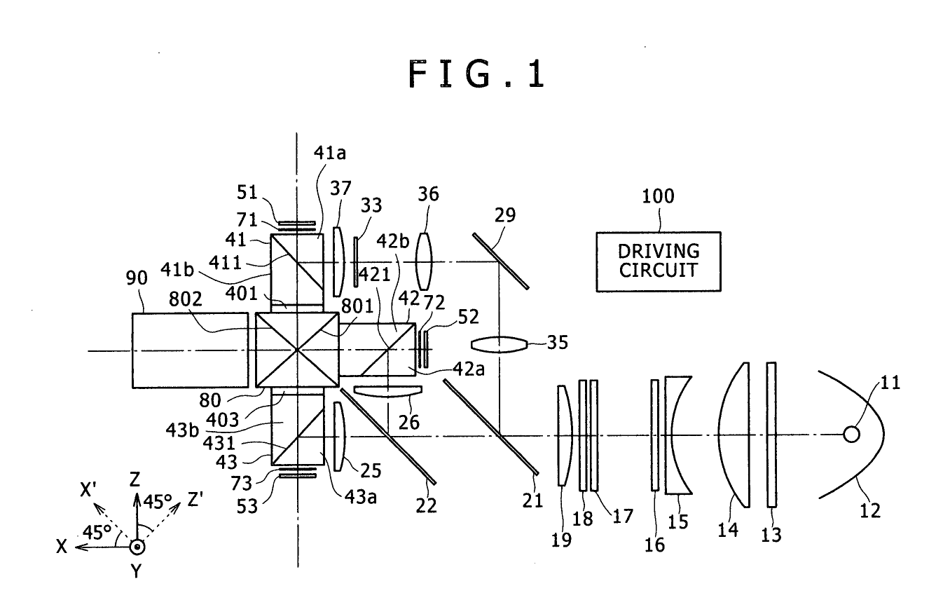

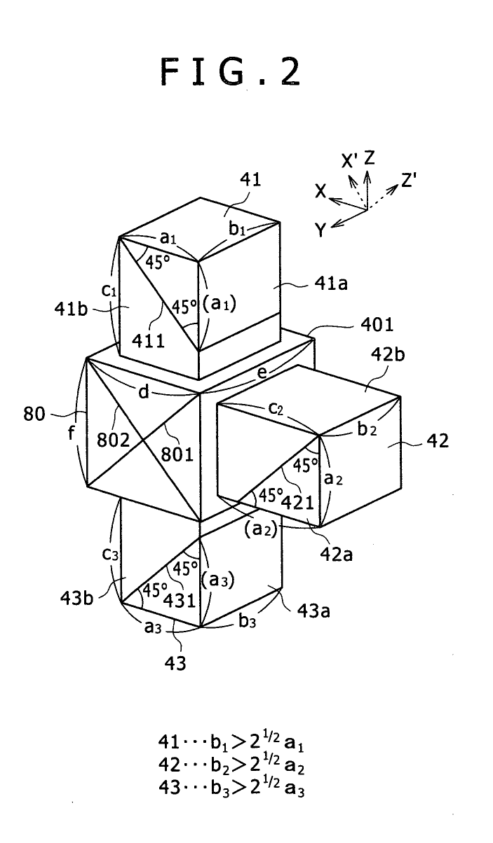

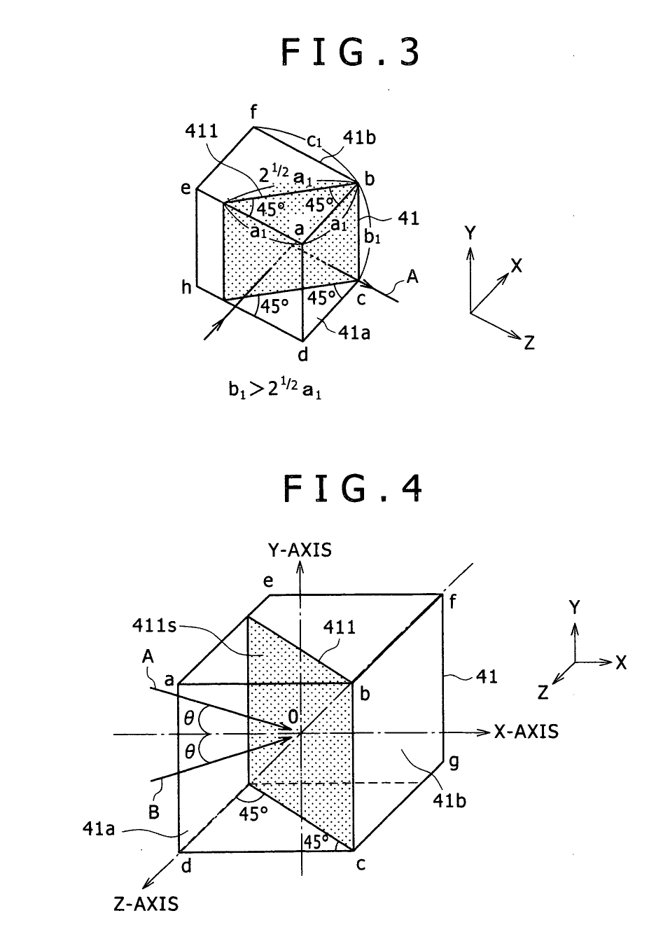

FIGS. 1 to 4 are diagrams of assistance in explaining a projection image display apparatus as an embodiment of the present invention. This embodiment is a projection image display apparatus (liquid crystal projector) using a reflection liquid crystal panel as a light valve. FIG. 1 is a block diagram of a projection image display apparatus as an embodiment of the present invention, FIG. 2 is an appearance view of a combined construction of polarization splitting units and a color combination unit of the projection image display apparatus of FIG. 1, FIG. 3 is an appearance view of a polarization splitting member forming the polarization splitting unit shown in FIG. 2, and FIG. 4 is a diagram of assistance in explaining incident angles of lights in the polarization splitting unit of the projection image display apparatus of FIG. 1.

In the projection image display apparatus of FIG. 1, the reference numeral 11 denotes a light source, the reference numeral 12 denotes a reflector in a parabolic reflecting surface shape, the reference numeral 13 denotes an ultraviolet cut filter for removing ultraviolet rays, and the reference numerals 14 and 15 denote collimate lenses for performing focusing and collimation. The reference numeral 16 denotes a first multi-lens array having plural rectangular lens cells and forming plural secondary light source images. The reference numeral 17 denotes a second multi-lens array having plural rectangular lens cells and forming individual lens cell images of the first multi-lens array 16. The reference numeral 18 denotes a polarization conversion device as a polarization conversion unit aligning the polarization direction of incident light and letting the incident light exit, as P-polarized light or S-polarized light. The reference numerals 19, 25, 26, and 37 denote focusing lenses. The reference numeral 21 denotes a red light reflecting dichroic mirror as a color splitting unit. The reference numeral 22 denotes a green light reflecting dichroic mirror as a color splitting unit. The reference numeral 35 denotes a relay lens. The reference numeral 36 denotes a field lens. The reference numeral 29 denotes a total reflection mirror. The reference numeral 33 denotes an infrared cut filter for removing infrared rays in red light. The reference numeral 51 denotes a red light reflection liquid crystal panel as a light valve for red light. The reference numeral 52 denotes a green light reflection liquid crystal panel as a light valve for green light. The reference numeral 53 denotes a blue light reflection liquid crystal panel as a light valve for blue light. The reference numeral 71 denotes a red light quarter-wave plate aligning the polarization direction of transmitted red light. The reference numeral 72 denotes a green light quarter-wave plate. The reference numeral 73 denotes a blue light quarter-wave plate. The reference numeral 41 denotes a red light polarization splitting unit polarization-splitting incident light. The reference numeral 42 denotes a green light polarization splitting unit. The reference numeral 43 denotes a blue light polarization splitting unit. The reference numerals 41a and 41b denote prism members in the red light polarization splitting unit 41. The reference numeral 411 denotes a polarization splitting film forming a polarization splitting plane in the red light polarization splitting unit 41. The reference numerals 42a and 42b denote prism members in the green light polarization splitting unit 42. The reference numeral 421 denotes a polarization splitting film forming a polarization splitting plane in the green light polarization splitting unit 42. The reference numerals 43a and 43b denote prism members in the blue light polarization splitting unit 43. The reference numeral 431 denotes a polarization splitting film forming a polarization splitting plane in the blue light polarization splitting unit 43. The reference numeral 401 denotes a redlight half-waveplate. The reference numeral 403 denotes a blue light half-wave plate. The reference numeral 80 denotes a cross dichroic prism as a color combination unit. The reference numerals 801 and 802 denote dichroic films of the cross dichroic prism 80. The reference numeral 90 denotes a projection lens unit for enlargeably projecting color-combined light onto a screen. The reference numeral 100 denotes a driving circuit driving the reflection liquid crystal panels 51, 52, and 53 according to an image signal.

The red light polarization splitting unit 41 polarization-splits light applied onto the red light reflection liquid crystal panel 51 and the light modulated by the reflection liquid crystal panel 51 by the polarization splitting plane of the red light polarization splitting film 411. Red light split by the red light reflecting dichroic mirror 21 is reflected by the polarization splitting film 411 to be applied onto the reflection liquid crystal panel 51 so that the red light reflected from the reflection liquid crystal panel 51 is guided to the cross dichroic prism. The green light polarization splitting unit 42 polarization-splits light applied onto the green light reflection liquid crystal panel 52 and the light modulated by the reflection liquid crystal panel 52 by the polarization splitting plane of the green light polarization splitting film 421. Red light split by the green light reflecting dichroic mirror 22 is reflected by the polarization splitting film 421 to be applied onto the reflection liquid crystal panel 52 so that the green light reflected from the reflection liquid crystal panel 52 is guided to the cross dichroic prism. The blue light polarization splitting unit 43 polarization-splits light applied onto the blue light reflection liquid crystal panel 53 and the light modulated by the reflection liquid crystal panel 53 by the polarization splitting plane of the blue light polarization splitting film 431. Blue light transmitted through the green light reflecting dichroic mirror 22 is reflected by the polarization splitting film 431 to be applied onto the reflection liquid crystal panel 53 so that the blue light reflected from the reflection liquid crystal panel 53 is guided to the cross dichroic prism.

According to this embodiment, in each of the polarization splitting planes of the polarization splitting films 411, 421, and 431, F number in a first direction of incident light (an axial direction in which an incident angle of light is small), that is, in the Y-axis direction in FIG. 1 is smaller than F number in a second direction of the incident light (an axial direction in which an incident angle of light is large), that is, in the Z′-axis direction or X′-axis direction in FIG. 1. In other words, the first direction is a direction (Y-axis direction) orthogonal to an optical axis of the incident light and orthogonal to a plane (YZ plane) including the optical axis and the normal to the polarization splitting plane, and the second direction is a direction (Z-axis direction) orthogonal to an optical axis of the incident light and in parallel with a plane (YZ plane) including the optical axis and the normal to the polarization splitting plane.

As described above, the present inventors have found that the amount of lowered contrast when an incident angle of light upon the polarization splitting plane is changed in the first direction is smaller than the amount of lowered contrast when an incident angle of light upon the polarization splitting plane is changed in the second direction. The present invention has been made in view of such findings and can increase the amount of incident light while suppressing lowered contrast by making F number in the first direction of an incident light upon the polarization splitting plane smaller than F number in the second direction thereof. In this embodiment, F number in the first direction in which the influence on contrast is small when an incident angle of light is large is reduced to suppress lowered contrast and enhance brightness. In the second direction, the influence on contrast is large when an incident angle of light is increased. In the second direction, preferably, the incident angle of light is not increased very much.

In this embodiment, the polarization splitting planes are in a rectangle or substantially rectangle shape (hereinafter, called a rectangle). In the polarization splitting film 411, the long side direction of the rectangle of the polarization splitting plane is the Y-axis direction and the short side direction thereof is the X′-axis direction. F number in the long side direction of the rectangle is smaller than F number of the short side direction. In the polarization splitting films 421 and 431, the long side direction of the rectangle of the polarization splitting planes is the Y-axis direction and the short side direction is the Z′-axis direction F number in the long side direction of the rectangle is smaller than F number in the short side direction thereof. Specifically, the ratio of the length in the long side direction to the length in the short side direction of the polarization splitting planes of the polarization splitting films 411, 421, and 431 is larger than the ratio of the lengths in the corresponding directions on the panel surfaces of the reflection liquid crystal panels 51, 52, and 53 (when the panel surfaces are in a rectangle shape, the long side direction of the polarization splitting films corresponds to the long side direction of the panel surfaces and the short side direction of the polarization splitting films corresponds to the short side direction of the panel surfaces).

The polarization splitting films 411, 421, and 431 may be of the prior art structure having a dielectric multilayer film or an organic multilayer film or may be of other structure. The polarization splitting planes have a lattice structure. Light may be polarization-split by diffraction based on the lattice structure.

In the construction of FIG. 1, light emitted from the light source 11 is reflected by the reflector 12 in a parabolic reflecting surface shape to be incident upon the ultraviolet cut filter 13. The light whose ultraviolet rays are removed by the ultraviolet cut filter 13 is collimated by the collimate lenses 14 and 15 and passes through the first array lens 16 and the second array lens 17 to form plural secondary light source images. The imaging light is incident upon the polarization conversion device 18 to be split into white P-polarized light and S-polarized light by a polarized beam splitter (not shown) in the polarization conversion device 18. The polarization direction of the split P-polarized light is rotated by the half-wave plate (not shown) in the polarization conversion device 18 to be the S-polarized light which is then incident upon the red light reflecting dichroic mirror 21 via the focusing lens 19 together with the S-polarized light split by the polarized beam splitter. Of the white S-polarized light, red S-polarized light is reflected by the color splitting film of the red light reflecting dichroic mirror 21 so that green S-polarized light and blue S-polarized light are transmitted therethrough. The reflected red S-polarized light passes through the relay lens 35 to be reflected by the total reflection mirror 29. It passes through the field lens 36, the infrared absorption filter 33, and the focusing lens 37 to be incident upon the red light polarization splitting unit 41.

In the red light polarization splitting unit 41, the red S-polarized light is reflected by the polarization splitting plane of the red light polarization splitting film 411. The reflected red S-polarized light whose polarization direction is aligned by the red light quarter-wave plate 71 is applied onto the red light reflection liquid crystal panel 51. In the reflection liquid crystal panel 51 driven by the driving circuit 100, the applied red S-polarized light is modulated and reflected according to an image signal to exit as red P-polarized light. The exiting red P-polarized light passes through the quarter-wave plate 71 to be incident upon the polarization splitting unit 41 again. In the red light polarization splitting unit 41, the red P-polarized light is transmitted through the polarization splitting plane of the red light polarization splitting film 411. The transmitted red P-polarized light passes through the prism member 41b portion in the polarization splitting unit 41 to exit from the polarization splitting unit 41. The light which passes through the half-wave plate 401 is converted to S-polarized light to be incident upon the cross dichroic prism 80. In the cross dichroic prism 80, the red S-polarized light is reflected by the dichroic film 801. Both the red S-polarized light and P-polarized light incident upon the polarization splitting plane of the red light polarization splitting film 411 are incident upon the polarization splitting plane at an incident angle of light of e.g., about ±10° with respect to the normal to the polarization splitting plane. This can increase the amount of incident light upon the polarization splitting plane. When an incident angle in the Y-axis direction is e.g., 10°, an angle between the incident angle of light and the normal to the polarization splitting plane is reduced to change within an incident angle of 45° to about 0.9°, as described later. The polarization-splitting performance on the polarization splitting plane of the polarization splitting film 411 is maintained in the best range.

The green S-polarized light and the blue S-polarized light which have transmitted through the red light reflecting dichroic mirror 21 are incident upon the green light reflecting dichroic mirror 22. The green S-polarized light is reflected by the color splitting film of the green light reflecting dichroic mirror 22 so that the blue S-polarized light is transmitted therethrough. The reflected green S-polarized light passes through the focusing lens 26 to be incident upon the green light polarization splitting unit 42. In the green light polarization splitting unit 42, the green S-polarized light is reflected by the polarization splitting plane of the green light polarization splitting film 421. The reflected green S-polarized light whose polarization direction is aligned by the green light quarter -wave plate 72 is applied onto the green light reflection liquid crystal panel 52. In the reflection liquid crystal panel 52 driven by the driving circuit 100, the applied green S-polarized light is modulated and reflected according to an image signal to exit as green P-polarized light. The exiting green P-polarized light passes through the quarter-wave plate 72 to be incident upon the polarization splitting unit 42 again. In the green light polarization splitting unit 42, the green polarized light is transmitted through the polarization splitting plane of the green light polarization splitting film 421. The transmitted green P-polarized light passes through the prism member 42b portion in the polarization splitting unit 42 to exit from the polarization splitting unit 42 and is then incident upon the cross dichroic prism 80. In the cross dichroic prism 80, the green P-polarized light is transmitted through the dichroic films 801 and 802. As in the red light, both the green S-polarized light and P-polarized light incident upon the polarization splitting plane of the green light polarization splitting film 421 are incident upon the polarization splitting plane at an incident angle of light of e.g., about ±10° with respect to the normal to the polarization splitting plane. This can increase the amount of incident light upon the polarization splitting plane. When an incident angle in the Y-axis direction is e.g., 10°, an angle between the incident angle of light and the normal to the polarization splitting plane is reduced to change within an incident angle of 45° to about 0.9°, as described later. The polarization-splitting performance on the polarization splitting plane of the polarization splitting film 411 is maintained in the best range.

The blue S-polarized light which has transmitted through the green light reflecting dichroic mirror 22 passes through the focusing lens 25 to be incident upon the blue light polarization splitting unit 43. In the blue light polarization splitting unit 43, the blue S-polarized light is reflected by the polarization splitting plane of the blue light polarization splitting film 431. The reflected blue S-polarized light whose polarization direction is aligned by the blue light quarter -wave plate 73 is applied onto the blue light reflection liquid crystal panel 53. In the reflection liquid crystal panel 53 driven by the driving circuit 100, the applied blue S-polarized light is modulated and reflected according to an image signal to exit as blue P-polarized light. The exiting blue P-polarized light passes through the quarter-wave plate 73 to be incident upon the polarization splitting unit 43 again. In the blue light polarization splitting unit 43, the blue P-polarized light is transmitted through the polarization splitting plane of the blue light polarization splitting film 431. The transmitted blue P-polarized light which passes through the half-wave plate 403 is converted to S-polarized light, which passes through the prism member portion in the polarization splitting unit 43 to exit from the polarization splitting unit 43 and is then incident upon the cross dichroic prism 80. In the cross dichroic prism 80, the blue S-polarized light is reflected by the dichroic film 802. As in the red light and the green light, both the blue S-polarized light and P-polarized light incident upon the polarization splitting plane of the blue light polarization splitting film 431 are incident upon the polarization splitting plane at an incident angle of light of e.g., about ±10° with respect to the normal to the polarization splitting plane. This can increase the amount of incident light upon the polarization splitting plane. When an incident angle in the Y-axis direction is e.g., 10°, an angle between the incident angle of light and the normal to the polarization splitting plane is reduced to change within an incident angle of 45° to about 0.9°, as described later. The polarization-splitting performance on the polarization splitting plane of the polarization splitting film 411 is maintained in the best range.

In the cross dichroic prism 80, the red S-polarized light exiting from the polarization splitting unit 41, the green P-polarized light exiting from the polarization splitting unit 42, and the blue S-polarized light exiting from the polarization splitting unit 43 are color-combined to exit as an optical image light of white light. The exiting optical image light is incident upon the projection lens unit 90 to be enlargeably projected on a screen for performing image display. When the quarter -wave plate is provided on the emitted plane of the cross dichroic prism 80 and all color lights of blue, red, and green are circularly polarized lights, reflection nonuniformity on the screen can be reduced.

The components of FIG. 1 used in the following description are indicated by the same reference numerals as those used in FIG. 1. In FIGS. 2 to 4, the same coordinate axes as those of FIG. 1 are used.

FIG. 2 is an appearance view of a combined construction of the polarization splitting units 41, 42, and 43 and the cross dichroic prism 80 as a color combination unit of the projection image display apparatus of FIG. 1.

In FIG. 2, the reference numerals a₁, b₁, and c₁ denote outer shape dimensions of the red light polarization splitting unit 41, in which a₁ denotes an outer shape dimension in the X-axis direction, b₁ denotes an outer shape dimension in the Y-axis direction, and c₁ denotes an outer shape dimension in the Z-axis direction. The reference numerals a₂, b₂, and c₂ denote outer shape dimensions of the green light polarization splitting unit 42, in which a₂ denotes an outer shape dimension in the Z-axis direction, b₂ denotes an outer shape dimension in the Y-axis direction, and c₂ denotes an outer shape dimension in the X-axis direction. The reference numerals a₃, b₃, and C₃ denote outer shape dimensions of the blue light polarization splitting unit 43, in which a₃ denotes an outer shape dimension in the X-axis direction, b₃ denotes an outer shape dimension in the Y-axis direction, and c₃ denotes an outer shape dimension in the Z-axis direction. The reference numerals d, e, and f denote outer shape dimensions of the cross dichroic prism 80, in which d denotes an outer shape dimension in the X-axis direction, e denotes an outer shape dimension in the Y-axis direction, and f denotes an outer shape dimension in the Z-axis direction. The polarization splitting film 411 of the red light polarization splitting unit 41 is disposed between the prism members 41a and 41b so as to be tilted at 45° with respect to the XY plane and the YZ plane. The polarization splitting film 411 is formed on its surface with a polarization splitting plane having a long side of length b₁ in the Y-axis direction and a short side of length 2^{1/2}a₁ in the X′-axis direction. The polarization splitting film 421 of the green light polarization splitting unit 42 is disposed between the prism members 42a and 42b so as to be tilted at 45° with respect to the Yc plane and the XY plane. The polarization splitting film 421 is formed on its surface with a polarization splitting plane having a long side of length b₂ in the Y-axis direction and a short side of length 2^{1/2}a₂ in the Z′-axis direction. The polarization splitting film 431 of the blue light polarization splitting unit 43 is disposed between the prism members 43a and 43b so as to be tilted at 45° with respect to the XY plane and the YZ plane. The polarization splitting film 431 is formed on its surface with a polarization splitting plane having a long side of length b₃ in the Y-axis direction and a short side of length 2^{1/2}a₃ in the Z′-axis direction. The outer shape dimensions a₁, a₂, and a₃ are substantially equal to each other. The outer shape dimensions b₁, b₂, and b₃ are substantially equal to each other. The outer shape dimensions c₁, c₂, and c₃ are substantially equal to each other. The outer shape dimensions d and f are substantially equal to each other. In addition, d is larger than a₁, and a₃, f is larger than a₂, and e is larger than b₁, b₂, and b₃. The red light polarization splitting unit 41 satisfies the relation of b₁>2^{1/2}a₁. The green light polarization splitting unit 42 satisfies the relation of b₂>2^{1/2}a₂. The blue light polarization splitting unit 43 satisfies the relation of b₃>2^{1/2}a₃.

The prism member 41b of the red light polarization splitting unit 41 is coupled to the cross dichroic prism 80 via the half-wave plate 401. The prism member 42b of the green light polarization splitting unit 42 is directly coupled to the cross dichroic prism 80. The prism member 43b of the blue light polarization splitting unit 43 is coupled to the cross dichroic prism 80 via the half-wave plate 403 (see FIG. 1). The polarization splitting plane of the polarization splitting film 411 of the red light polarization splitting unit, 41 is arranged in parallel with the film surface of the dichroic film 802 of the cross dichroic prism 80. The polarization splitting plane of the polarization splitting film 421 of the green light polarization splitting unit 42 and the polarization splitting plane of the blue light polarization splitting film 431 are arranged in parallel with the film surface of the dichroic film 801.

FIG. 3 is an appearance view of polarization splitting members forming the polarization splitting units shown in FIG. 2. FIG. 3 shows an appearance view of the polarization splitting member forming the red light polarization splitting unit 41. The polarization splitting member forming the green light polarization splitting unit 42 and the polarization splitting member forming the blue light polarization splitting unit 43 basically have the same construction as that of the polarization splitting member forming the red light polarization splitting unit 41.

In FIG. 3, S-polarized light A of red light incident from the focusing lens 37 (see FIG. 1) side in the substantially X-axis direction is reflected by the polarization splitting plane of the red light polarization splitting film 411 in the substantially Z-axis direction. Here, the aspect ratio of the plane of light incidence of the polarization splitting unit is larger than that of the display surface of the reflection liquid crystal panel. When the aspect ratio of the display surface of the reflection liquid crystal panel has a wide aspect ratio (that is, 16:9), the aspect ratio of the plane of light incidence of the polarization splitting unit is larger than that. Specifically, the aspect ratio is preferably 18/9 to 25/9. The upper limit value is determined by the ratio of F number in the second direction and F number in the first direction. For instance, when the upper limit of the ratio of F number in the second direction to F number in the first direction is about 1.4, 1.4×16/9=22.4. Here, in consideration of slight margin, it is 25. In such construction, F number in the Y-axis direction can be larger than F number in the Z-axis direction. The amount of incident light in the Y-axis direction of the plane of light incidence of the polarization splitting unit can be increased.

In the present invention, as described in FIGS. 1 and 2, F number in the Y-axis direction on the polarization splitting plane of the polarization splitting film 411 can be smaller than F number in the Z′-axis direction thereon. The amount of incident light upon the polarization splitting plane can be increased. The amount of change in incident angle of light upon the polarization splitting plane, that is, the amount of change in incident angle with respect to an incident angle of 45° can be reduced to a small value not to cause deteriorated contrast.

FIG. 4 is a diagram of assistance in explaining incident angles of light upon the polarization splitting film in the polarization splitting unit of the projection image display apparatus of FIG. 1. In FIG. 4, the above features and construction of the present invention in the case of the polarization splitting film 411 in the red light polarization splitting unit 41 will be described. The polarization splitting units 42 and 43 are basically the same as the polarization splitting unit 41.

In FIG. 4, the reference numeral 411s denotes a polarization splitting plane of the polarization splitting film 411, the reference numerals A and B respectively denote S-polarized lights of red light incident upon the polarization splitting plane 411s from sides of a, e, h, and d of the planes of the polarization splitting member, in which A denotes light incident in the θ angle direction to the X-axis (the direction of an incident angle of 45° with respect to the polarization splitting plane 411s) in the XY plane, that is, incident light tilted at η in the Y-axis direction (hereinafter, called incident light A) and B denotes light incident in the θangle direction to the X-axis in the XZ plane (hereinafter, called incident light B), and O denotes an incident point of the incident light A or the incident light B on the polarization splitting plane 411s.

The amount of change in incident angle φ_{A} at an incident angle of 45° of the incident light A is expressed by the following equation 1 to an angle θ to the X-axis in the XY plane.
φ_{A}=cos⁻¹(|sin θ|/2^{1/2} tan θ) (equation 1)

The amount of change in incident angle f_{B} at an incident angle of 45° of the incident light B is expressed by the following equation 2 to an angle θ to the X-axis in the XZ plane.
φ_{B}=cos⁻¹(|sin θ|/2^{1/2}(1/tan θ−1) (equation 2)

For instance, when θ=10°, from the equations 1 and 2, φ_{A}=0.9° and φ_{B}=10°. As a result, in the case of the incident light A, that is, when light is incident upon the polarization splitting plane 411s in the direction tilted at 10° to the X-axis (the direction at an incident angle of 45° with respect to the polarization splitting plane 411s) in the XY plane, that is, in the direction at an incident angle of 55°, the amount of change in incident angle at an incident angle of 45° in which polarization-splitting performance is best can be a small value of 0.9°.

The polarization-splitting performance of light on the polarization splitting plane 411s is maintained at almost the same level as the polarization-splitting performance at an incident angle of 45° and is maintained at the level in the best range, as in an incident angle of 45°. When θ is an angle smaller than 10°, the amount of change in incident angle φ_{A} is smaller than 0.9°. The polarization-splitting performance of light of the polarization splitting plane 411s has a value closer to the best polarization-splitting performance at an incident angle of 45°. In the case of the incident light B, that is, when light is incident upon the polarization splitting plane 411s in the direction tilted at 10° to the X-axis (the direction at an incident angle of 45° with respect to the polarization splitting plane 411s) in the XZ plane, that is, in the direction at an incident angle of 55°, the amount of change in incident angle at an incident angle of 45° can be a large value of 10°.

The polarization-splitting performance of light on the polarization splitting plane 411s is greatly lower than that at an incident angle of 45°. Light is incident upon the polarization splitting plane 411s in the XY plane so as to be tilted to the X-axis (the direction at an incident angle of 45° with respect to the polarization splitting plane 411s), that is, in the Y-axis direction. The amount of change in incident angle can be small. The amount of incident light upon the polarization splitting plane 411s can be increased.

Reducing the amount of change in incident angle can maintain the polarization-splitting performance on the polarization splitting plane 411s in the best range to secure image contrast performance. Increasing the amount of incident light can enhance image brightness. In the above construction, both securing image contrast performance and enhancing brightness can be done. The incident angle of light θ of the incident light A is preferably about 10° in the X-axis direction (the direction at an incident angle of 45° with respect to the polarization splitting plane 411s) in the XY plane and may be larger than that.

The description in FIG. 4 is about the polarization splitting film 411 of the red light polarization splitting unit 41. The polarization splitting film 421 of the green light polarization splitting unit 42 and the polarization splitting film 431 of the blue light polarization splitting unit 43 are the same as the polarization splitting film 411 of the red light polarization splitting unit 41.

According to the above embodiment, the projection image display apparatus of a simple construction without increasing the number of parts can secure image contrast performance and enhance brightness.

According to the above embodiment, three light valves, that is, three reflection liquid crystal panels are used. The present invention is not limited to this. One light valve may be used. According to the above embodiment, the polarization splitting planes of the polarization splitting films 411, 421, and 431 are in a rectangle shape. The present invention is not limited to this. They may be of other shapes. The same is true for the polarization splitting films 411, 421, and 431.

The present invention can be embodied in other embodiments without departing from its spirit or main features The above embodiment is only an example of the present invention in view of all points and should not be limitatively understood. The scope of the present invention is shown by the scope of claims. Modifications and changes as fall within the scope of claims are all within the scope of the present invention.

What is claimed is:

1. A projection image display apparatus which modulates light from a light source side in accordance with an image signal by a light valve to form and enlargeably project an optical image, comprising:
a polarization conversion unit that aligns a polarization direction of the light from the light source side to form P-polarized light or S-polarized light;
a color splitting unit that splits the polarization-converted polarized light into color lights of red, green, and blue;
a light valve illuminated with polarized light of the split color light that modulates the polarized light based on the image signal;
a polarization splitting unit that has a polarization splitting plane polarization-splitting the light formed between prism members and polarization-splits on the polarization splitting plane the light applied onto the light valve and the light modulated by the light valve;
a color combination unit that color-combine the polarization-split lights;
a projection lens unit that enlargeably projects the color-combined light; and
a driving circuit that drives the light valve,
wherein F number in a first direction of incident light upon the polarization splitting plane of the polarization splitting unit is smaller than F number in a second direction of the incident light in such a manner that the first direction of the incident light is a direction orthogonal to an optical axis of the incident light and orthogonal to a plane including the optical axis and the normal to the polarization splitting plane, and the second direction of the incident light is a direction orthogonal to an optical axis of the incident light and in parallel with a plane including the optical axis and the normal to the polarization splitting plane.

2. The projection image display apparatus according to claim 1, wherein the polarization splitting plane is in a rectangle shape, the first direction of the incident light is a long side direction of the rectangle, and the second direction of the incident light is a short side direction of the rectangle.

3. The projection image display apparatus according to claim 1, wherein an incident angle of light in the first direction of the incident light is larger than that in the second direction of the incident light.

4. An optical unit for a projection image display apparatus which polarization-converts light from a light source side to apply it onto a light valve to form and enlargeably project an optical image in accordance with an image signal, comprising:
a polarization splitting unit that has a polarization splitting plane polarization-splitting the light formed between prism members and polarization-splits on the polarization splitting plane the light applied onto the light valve and the light modulated by the light valve;
a color combination unit that color-combines the polarization-split lights; and
a projection lens unit that enlargeably projects the color-combined light,
wherein F number in a first direction of incident light upon the polarization splitting plane of the polarization splitting unit is smaller than F number in a second direction of the incident light in such a manner that the first direction of the incident light is a direction orthogonal to an optical axis of the incident light and orthogonal to a plane including the optical axis and the normal to the polarization splitting plane, and the second direction of the incident light is a direction orthogonal to an optical axis of the incident light and in parallel with a plane including the optical axis and the normal to the polarization splitting plane.

5. A projection image display apparatus comprising:
a light source;
a polarization conversion unit that aligns a polarization direction of light from the light source to form P-polarized light or S-polarized light;
a color splitting unit that splits the polarization-converted polarized light into color lights of red, green, and blue;
a light valve illuminated with polarized light of the split color light that modulates the polarized light based on the image signal;
a color combination unit that color-combines the lights modulated by the light valve;
a polarization splitting unit having a polarization splitting plane polarization-splitting the light formed between prism members, reflects by the polarization splitting plane the color light split by the color splitting unit to apply it onto the light valve, and guides the light reflected by the light valve to the color combination unit; and
a projection lens unit that enlargeably projects the color-combined light,
wherein an incident plane upon which the light of the polarization splitting unit is incident is in a rectangle shape and an aspect ratio of the incident plane is larger than 16:9.

6. The projection image display apparatus according to claim 5, wherein the aspect ratio of the light incident plane of the polarization splitting unit is 18:9 to 24:9.
